(19) United States
(12) Patent Application Publication
(10) Pub. No.: US 2013/0091495 A1
(43) Pub. Date: Apr. 11, 2013

(54) FEEDBACK-DIRECTED RANDOM CLASS UNIT TEST GENERATION USING SYMBOLIC EXECUTION

(71) Applicant: NEC Laboratories America, Inc., Princeton, NJ (US)

(72) Inventors: Pranav Garg, Urbana, IL (US); Franjo Ivancic, Princeton, NJ (US); Gogul Balakrishnan, Plainsboro, NJ (US); Naoto Maeda, Kawasaki (JP); Aarti Gupta, Princeton, NJ (US)

(73) Assignee: NEC Laboratories America, Inc., Princeton, NJ (US)

(21) Appl. No.: 13/646,390

(22) Filed: Oct. 5, 2012

Related U.S. Application Data
(60) Provisional application No. 61/543,855, filed on Oct. 6, 2011.

(51) Int. Cl. G06F 9/44

(52) U.S. Cl. 717/131

(57) ABSTRACT

Methods and systems for generating software analysis test inputs include generating a path query to cover a target branch of a program by executing a symbolic test driver concretely and partially symbolically, where at least one symbolic expression is partially concretized with concrete values; determining whether it is feasible to execute the target branch based on whether the generated path query is satisfiable or unsatisfiable using a constraint solver; if the target branch is feasible, generating a new test driver by replacing symbolic values in the symbolic test driver with generated solution values; and if the target branch is not feasible, analyzing an unsatisfiable core to determine whether unsatisfiability is due to a concretization performed during generation of the path query.

### RELATED APPLICATION INFORMATION

This application claims priority to provisional application Ser. No. 61/543,855 filed on Oct. 6, 2011, incorporated herein by reference.

### BACKGROUND

1. Technical Field

The present invention relates to software analysis and, more particularly, to automatically generating test inputs for programs under analysis.

2. Description of the Related Art

With the omnipresence of software in society, there is a growing need to provide effective development and verification for software. Analyzing and testing software for its correctness is also a key step in guaranteeing the safety of many important embedded devices, such as medical devices, automobiles, and airplanes. In industry, software testing and coverage-based metrics are used to check software systems for correctness.

Existing techniques for finding test inputs generally need a user to mark certain variables as testing targets, so that an exploration of the input space can occur. Techniques such as random value assignments or symbolic/concolic executions are used to explore as many paths as possible based on the user-marked input variables. These test input generation techniques require user input and manipulations of the code under analysis.

A technique called Randoop attempts to address these problems by automatically generating test driver programs for object-oriented programs written in Java® without user intervention. However, Randoop relies on feedback-guided test drivers that utilize only random values as generated test inputs. Furthermore, Randoop generally cannot cover certain deep parts of programs or branches that are simply unlikely to be covered using pure random methods.

### SUMMARY

A method for generating software analysis test inputs is shown that includes generating a path query to cover a target branch of a program by executing a symbolic test driver concretely and partially symbolically, where at least one symbolic expression is partially concretized with concrete values; determining whether it is feasible to execute the target branch based on whether the generated path query is satisfiable or unsatisfiable using a constraint solver; if the target branch is feasible, generating a new test driver by replacing symbolic values in the symbolic test driver with generated solution values; and if the target branch is not feasible, analyzing an unsatisfiable core to determine whether unsatisfiability is due to a concretization performed during generation of the path query.

A method for generating software analysis test inputs is shown that includes generating a path query to cover a target branch of a program by executing a symbolic test driver concretely and partially symbolically, where at least one symbolic expression is partially concretized with concrete values; determining whether it is feasible to execute the target branch based on whether the generated path query is satisfiable or unsatisfiable using a constraint solver; if the target branch is feasible, generating a new test driver by replacing symbolic values in the symbolic test driver with generated solution values; if the target branch is not feasible, analyzing an unsatisfiable core to determine whether unsatisfiability is due to a concretization performed during generation of the path query; if unsatisfiability is due to a concretization, generating a second path query to cover the target branch by executing the symbolic test driver concretely and partially symbolically, where symbolic expressions due to non-linearities are not concretized; determining whether it is feasible to execute the target branch based on whether the second path query is satisfiable by resolving the generated second path query using a non-linear constraint solver; and if the target branch is feasible, generating a new test driver by replacing the symbolic values in the test driver with generated solution values.

A system for generating software analysis test inputs is shown that includes a concolic analyzer configured to generate a path query to cover a target branch of a program by executing a symbolic test driver concretely and partially symbolically, where at least one symbolic expression is partially concretized with concrete values; a constraint solver configured to determine whether it is feasible to execute the target branch based on whether the generated path query is satisfiable or unsatisfiable; and a processor configured to generate a new test driver by replacing symbolic values in the symbolic test driver with generated solution values if the target branch is feasible and to analyze an unsatisfiable core to determine whether unsatisfiability is due to a concretization performed during generations of the path query if the target branch is not feasible.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a high-level diagram of test driver generation according to the present principles.

FIG. 2 is a diagram of automatic test driver generation with random test driver generation and concolic test driver generation according to the present principles.

FIG. 3 is a block/flow diagram of a method for generating test drivers according to the present principles.

FIG. 4 is a diagram of a software analysis system configured to generate test inputs according to the present principles.

### DETAILED DESCRIPTION OF PREFERRED EMBODIMENTS

The present principles provide test driver generation without user intervention and without having to mark certain variables as test inputs. Furthermore, the present principles use concolic execution methods to allow generation of tests that cover portions of the program under analysis that previous attempts have been unable to reach, without user intervention. To accomplish this, the present embodiments automatically infer locations where variables need to be marked as potential symbolic test inputs, so that concolic execution methods can be used to extend the coverage of randomly generated tests. Furthermore, the present principles may be adapted to handle C/C++ code, expanding the potential targets for software analysis. As a result, higher quality test inputs may be automatically generated, lowering the software testing costs that dominate software development and maintenance costs.

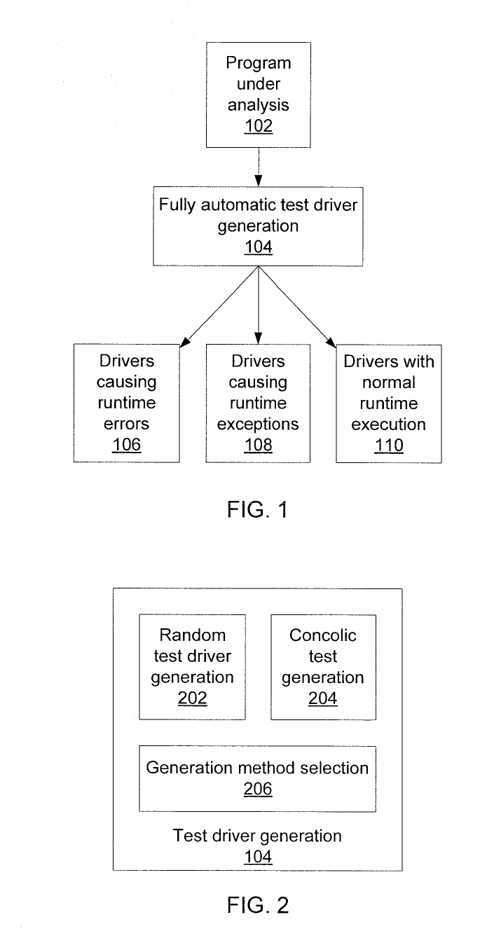

Referring now to FIG. 1, a high-level diagram of test driver generation according to the present principles is shown. A program under analysis 102 is provided and test drivers are automatically generated 104. The test drivers may be classified into three bins: test drivers that cause the program to run into a runtime error 106, such as segmentation faults or assertion violations; test drivers that cause the program to throw an uncaught exception at runtime 108; and drivers that have normal runtime execution behavior 110, in that the driver did not match the classification of bins 106 and 108. The test drivers in the third bin 110 are regarded as normal because they have not yet exhibited any irregular behavior. Implicit invariants of the program analysis that may be violated for test drivers in the “normal” bin 110, but which have not been explicitly checked, are disregarded.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Embodiments described herein may be entirely hardware, entirely software or including both hardware and software elements. In a preferred embodiment, the present invention is implemented in software, which includes but is not limited to firmware, resident software, microcode, etc.

Referring now to FIG. 2, further detail regarding automatic test driver generation 104 is provided. The present principles combine the strengths of two complimentary methods in utilizing automated, directed-random test generation 202 with concolic execution based methods 204 that often need user intervention in marking relevant test inputs.

Selecting 206 between the test driver generation methods 202 and 204 depends on the historical performance of each. Generally speaking, random test driver generation is effective in early testing stages, but random generation reaches a performance plateau. At the plateau stage, the present embodiments switch to the concolic execution engine 204 to extend some test drivers that have been discovered and to try to extend into as-yet uncovered program regions. The coverage metrics on the control flow graph (CFG) of the program under analysis are thus also used to decide on switching test generation methods.

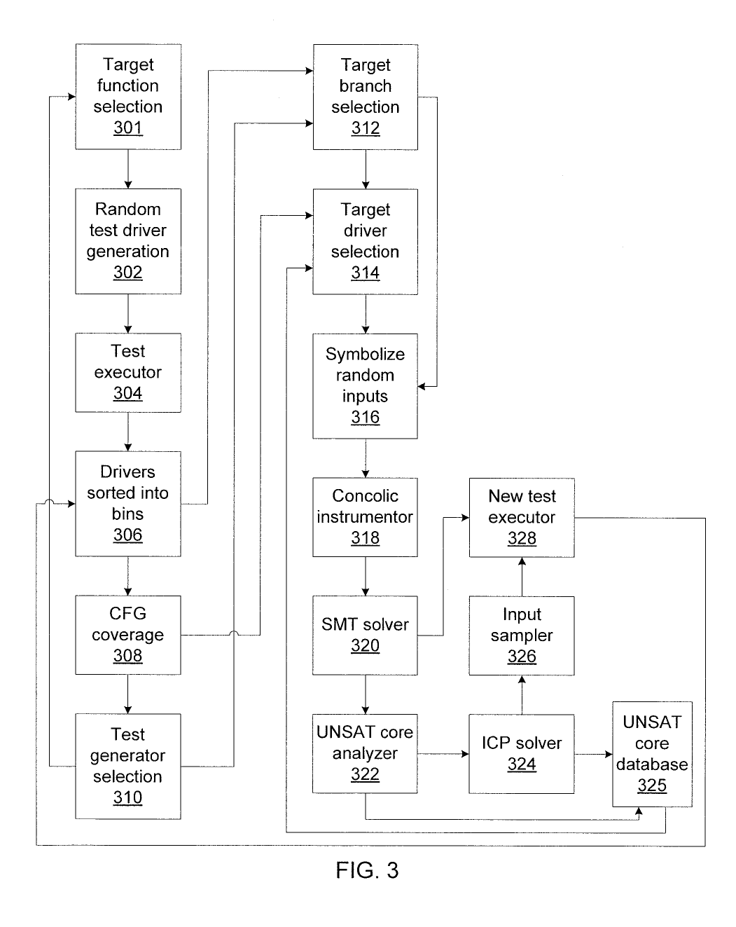

Referring now to FIG. 3, a detailed diagram of an embodiment of a test generation system is shown. Assume that the state begins with a low enough CFG coverage that random test driver generation is selected. A target function is selected at block 301 and a random test driver is generated at block 302. The test 304 is executed on a program being analyzed, producing results that are sorted into bins at block 306. Based on the drivers already sorted into bins 306, a CFG coverage is generated at block 308 and a subsequent test generator is selected at block 310. If random selection is still productive, based on historic results in the CFG coverage, the random generator path is selected and processing returns to block 301.

However, if directed-random test generation reaches a performance plateau, test generator selection 310 switches to a concolic execution path. The concolic path begins at target branch selection 312, which selects a branch based on prior runs using the sorted drivers 306. Based on the target branch, a subset of current test drivers are selected at block 314, based on CFG coverage, that are good candidates to reach the target branch.

Randomly generated test drivers have certain input parameters that are randomly chosen. This information is recovered and turned into symbolic variables 316 that can be searched over for new input values. When choosing a target branch, it is already known whether a branch is potentially symbolic or not, allowing checks for branches that are not symbolic to be discarded.

Based on concolic instrumentation at block 318, a path query with a target branch check is created for which a satisfiability modulo theory (SMT) solver 320 may find a new test input that should lead the execution down that path. If the SMT solver 320 returns a value that satisfies the formula at hand, the test driver is executed at block 328. This adds the new path to one of the three bins 306 based on its execution outcome.

If the SMT solver 320 returns with the answer “unsatisfiable,” there is no possible value for the symbolic variables that will reach the target branch given the current concolically instrumented path. However, the concolic instrumentation at block 318 may be quite restrictive in terms of which symbolic variables have been partially concretized due to non-linear arithmetic computations on the program under analysis. In such a case, the SMT solver 320 also returns an unsatisfiable core. The unsatisfiable core is analyzed at block 322 to discover whether it includes only parts of the SMT formula that related to the path and fully symbolic evaluations. That is, determining that no constraint in the unsatisfiable core is due to a concretization or approximation. In such a case, the unsatisfiable core may be stored in a database 325 for future use. In particular, these stored cores allow for quick decisions as to which test drivers cannot be extended to hit a target branch based on prior unsatisfiable answers.

If the unsatisfiable core includes elements of partial concretizations, it is not clear that the target branch may not be reachable using the same path with a different evaluation of the test input. To decide whether it is infeasible to execute the target branch on the current path, an interval constraint propagation (ICP) solver 324 is consulted, where the ICP solver 324 can handle non-linear arithmetic. Should the ICP solver 324 also report that the path is unsatisfiable, that information is stored in the unsatisfiable core database 325. However, the ICP solver 324 may return possible solution boxes of interest for the input variables. A random sampling in the solution boxes may be performed at block 326 to find candidate test inputs for new test runs. Should a test input result in a program execution that reaches the target branch, the test driver is stored in one of the bins 306. Processing then returns as stated above to a determination of CFG coverage 308 and a selection of generation method at 310. The present principles thereby allow extension of the capabilities of directed random test driver generation to find potential solutions for complex non-linear path formulas.

Tests generated in the concolic path above have the same code structure as their parent tests, but only differ in their inputs. Any two tests generated from the same parent test often share large portions of their execution traces. When a path in a particular test driver to a target branch is infeasible, the unsatisfiable cores are stored in database 325 and used to generalize the reason of infeasibility in the path. These unsatisfiable cores can be used in the future to rule out infeasible paths during concolic execution of related test cases. The unsatisfiable core of an unsatisfiable formula is used to extract structural reasons for the infeasibility of the corresponding path. This is achieved by semantically annotating constraints obtained in the concolic execution with a set of responsible control flow edges.

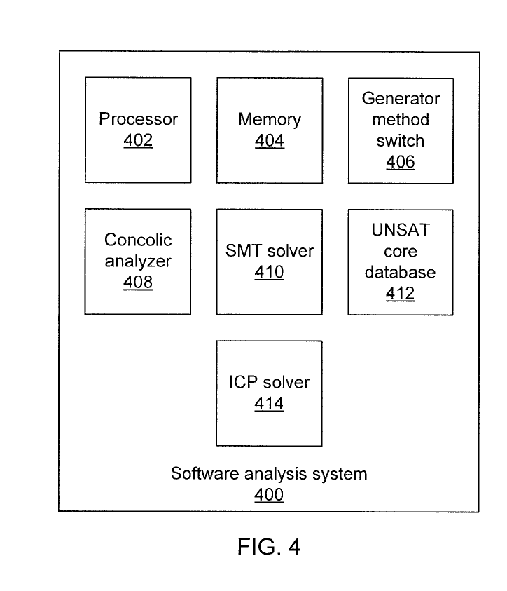

Referring now to FIG. 4, a software analysis system is shown that performs the above-described methods. A generator method switch 406 uses processor 402 to select between directed random test driver generation and concolic execution based test driver generation based on historic test driver results stored in memory 404. If concolic test generation is selected, the processor 402 represents the random drivers symbolically for concolic instrumentor 408. An SMT solver 410 determines whether the test driver produces unsatisfiable results, with the cores of such drivers being stored in an UNSAT core database 412. An ICP solver 414 provides solution boxes for further analysis, such that the processor 402 can employ random-directed sampling inside said solution boxes to generate new test drivers.

Having described preferred embodiments of a system and method for feedback-directed random class unit test generation using symbolic execution (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for generating software analysis test inputs, comprising:
generating a path query to cover a target branch of a program by executing a symbolic test driver concretely and partially symbolically, where at least one symbolic expression is partially concretized with concrete values;
determining whether it is feasible to execute the target branch based on whether the generated path query is satisfiable or unsatisfiable using a constraint solver;
if the target branch is feasible, generating a new test driver by replacing symbolic values in the symbolic test driver with generated solution values; and
if the target branch is not feasible, analyzing an unsatisfiable core to determine whether unsatisfiability is due to a concretization performed during generation of the path query.

2. The method of claim 1, further comprising generating a second path query that is less concrete than the original path query.

3. The method of claim 1, further comprising selecting between a concolic test generation path and a directed-random test generation path.

4. The method of claim 1, wherein the constraint solver is a satisfiability modulo theory solver.

5. The method of claim 1, further comprising storing unsatisfiable cores in a database for use in test driver selection.

6. A method for generating software analysis test inputs, comprising:
generating a path query to cover a target branch of a program by executing a symbolic test driver concretely and partially symbolically, where at least one symbolic expression is partially concretized with concrete values;
determining whether it is feasible to execute the target branch based on whether the generated path query is satisfiable or unsatisfiable using a constraint solver;
if the target branch is feasible, generating a new test driver by replacing symbolic values in the symbolic test driver with generated solution values;
if the target branch is not feasible, analyzing an unsatisfiable core to determine whether unsatisfiability is due to a concretization performed during generation of the path query;
if unsatisfiability is due to a concretization, generating a second path query to cover the target branch by executing the symbolic test driver partially concretely and partially symbolically, where symbolic expressions due to non-linearities are not concretized;
determining whether it is feasible to execute the target branch based on whether the second path query is satisfiable by resolving the generated second path query using a non-linear constraint solver; and
if the target branch is feasible, generating a new test driver by replacing the symbolic values in the test driver with generated solution values.

7. The method of claim 6, wherein determining whether execution of a target branch is infeasible based on the second path query is performed using a non-linear solver to find candidate solutions to non-linear concolic path formulas.

8. The method of claim 7, wherein the non-linear solver is an interval constraint propagation solver.

9. The method of claim 8, wherein the candidate solutions comprise one or more solution boxes based on the unsatisfiable core using random-directed sampling.

10. A system for generating software analysis test inputs, comprising:
a concolic analyzer configured to generate a path query to cover a target branch of a program by executing a symbolic test driver concretely and partially symbolically, where at least one symbolic expression is partially concretized with concrete values;
a constraint solver configured to determine whether it is feasible to execute the target branch based on whether the generated path query is satisfiable or unsatisfiable; and
a processor configured to generate a new test driver by replacing symbolic values in the symbolic test driver with generated solution values if the target branch is feasible and to analyze an unsatisfiable core to determine whether unsatisfiability is due to a concretization performed during generations of the path query if the target branch is not feasible.
